(19) United States
(12) Patent Application Publication
(10) Pub. No.: US 2019/0277359 A1
(43) Pub. Date: Sep. 12, 2019

(54) DOUBLE LAYER WET FRICTION MATERIAL

(71) Applicant: Schaeffler Technologies AG & Co. KG, Herzogenaurach (DE)

(72) Inventors: Rashid FARAHATI, Copley, OH (US); Murat BAKAN, Wooster, OH (US)

(21) Appl. No.: 15/913,354

(22) Filed: Mar. 6, 2018

(51) Int. Cl. F16D 69/02; B32B 27/34; B32B 27/12; B32B 27/20

(52) U.S. Cl. CPC F16D 69/026; B32B 27/34; F16D 2069/003; B32B 27/20; B32B 27/12

(57) ABSTRACT

A method of making a wet friction material is provided. The method includes obtaining a base layer sheet; obtaining an outer layer sheet; and laminating the outer layer sheet and the base layer sheet together to form the wet friction material. The base layer sheet includes a proportion of first fiber material and a proportion of first filler material and the outer layer sheet includes a proportion of second fiber material and a proportion of second filler material. The proportion of second fiber material is less than the proportion of first fiber material and the proportion of second filler material is greater than the proportion of first filler material.

The present disclosure relates generally to friction clutches and plates used in torque converters and motor vehicle transmissions and more specifically to wet friction material.

### BACKGROUND

The friction material in wet-type friction clutches generally operates in an oil submerged environment and is often paper-based material used to form friction material rings. Most state of the art wet friction material uses coating fillers in top of base paper. It is known to spray or sprinkle diatomaceous earth sold under the trade name CELITE on top of the base materials directly during the paper making process in a Fourdrinier machine at the wet end of the machine when the paper base material is being moved along a conveyor. This process is good for very high volume papers, but there is large waste during initial set up, so it is not practical for smaller volume production.

U.S. Pub. 2017/0089415 discloses friction material including a bottom layer and a top layer forming a paper composite, with pores being created by a laser in the top surface.

U.S. Pub. 2017/0261057, U.S. Pub. 2006/0008635, U.S. Pub. 2017/0335913 and U.S. Pat. No. 9,499,759 disclose friction material including two or more layers.

### SUMMARY OF THE INVENTION

A method of making a wet friction material is provided. The method includes obtaining a base layer sheet; obtaining an outer layer sheet; and laminating the outer layer sheet and the base layer sheet together to form the wet friction material. The base layer sheet includes a proportion of first fiber material and a proportion of first filler material and the outer layer sheet includes a proportion of second fiber material and a proportion of second filler material. The proportion of second fiber material is less than the proportion of first fiber material and the proportion of second filler material is greater than the proportion of first filler material.

According to embodiments of the method, the base layer sheet has a first thickness, the outer layer sheet has a second thickness, the wet friction material may have a total thickness equaling the first thickness plus the second thickness, and the second thickness may be 10% to 30% of the total thickness. The second filler material may consist of disc-shaped diatomaceous earth. The second fiber material may consist of cellulose fibers. The first filler material may be formed by one or more fillers from a group consisting of diatomaceous earth, clay and/or graphite. The first filler material may consist of diatomaceous earth. The first fiber material may consist of aramid fibers and cellulose fibers. The first fiber material may consist of aramid fibers. The first fiber proportion may be 35 to 60% by percentage weight of the base layer sheet. The diatomaceous earth may form 35 to 55% by percentage weight of the outer layer sheet. The laminating of the outer layer sheet on the base layer sheet may include includes providing a binder into a porous matrix of the base layer sheet and applying heat and pressure to the outer layer sheet to fix the outer layer sheet and the base layer sheet together.

A clutch assembly is also provided including a metal part and the wet friction material fixed on the metal part.

A wet friction material is also provided. The wet friction material includes a base layer sheet and an outer layer sheet laminated onto the base layer sheet. The base layer sheet includes a proportion of first fiber material and a proportion of first filler material. The outer layer sheet includes a proportion of second fiber material and a proportion of second filler material. The proportion of second fiber material is less than the proportion of first fiber material. The proportion of second filler material is greater than the proportion of first filler material.

According to embodiments of the wet friction material, the base layer sheet has a first thickness and the outer layer sheet has a second thickness, the wet friction material may have a total thickness equaling the first thickness plus the second thickness and the second thickness may be 10% to 30% of the total thickness. The second filler material may consist of diatomaceous earth. The second fiber material may consist of cellulose fibers. The first filler material may consist of diatomaceous earth. The first fiber material may consist of aramid fibers or aramid fibers and cellulose fibers. The first fiber proportion may be 35 to 60% by percentage weight of the base layer sheet. The diatomaceous earth may form 35 to 55% by percentage weight of the outer layer sheet.

### BRIEF DESCRIPTION OF THE DRAWINGS

The present disclosure is described below by reference to the following drawings, in which:

FIG. 1 shows a base layer sheet and an outer layer sheet for forming the wet friction material in accordance with one embodiment of the present disclosure;

FIG. 2 shows the outer layer sheet being laminated to the base layer sheet;

FIG. 3 shows the resulting laminated wet friction material;

FIG. 4 shows the wet friction material being fixed to a metal clutch part; and

FIG. 5 shows a lockup clutch assembly of a torque converter including the wet friction material with orifices in the outer layer sheet.

### DETAILED DESCRIPTION

The present disclosure provides embodiments of wet friction materials exhibiting durability and effective friction performance in the high temperature applications, e.g., 150° C. or higher, by providing a thin layer having effective friction performance, which includes fibers that are at least 90% cellulose fibers, and in one embodiment are 100% cellulose fibers, with a high percentage of fillers, laminated on top of a thick base layer sheet formed of synthetic fibers.

FIGS. 1 to 4 schematically illustrate a method of forming a wet friction material and a clutch assembly in accordance with an embodiment of the present disclosure. A base wet friction material layer 10 is manufactured separately from an outer layer sheet 12. FIG. 1 shows base layer sheet 10 and outer layer sheet 12 as preformed separate pieces, in contrast to the conventional techniques that add friction modifiers to the base layer during the paper making process.

Base layer sheet 10 is a wet friction material formed of fibers, filler material and a binder. In one preferred embodiment, the fibers are 60 to 100% by percentage weight synthetic fibers, for example aramid fibers, but can also include cellulose fibers, carbon fibers and/or fiberglass. In another preferred embodiment, the fibers are 75 to 90% by percentage weight synthetic fibers. Cellulose fibers can be in cotton linter or wood pulp form. The fillers can be diatomaceous earth and/or clay. The binder can be a phenolic resin, a latex or a silane. Optionally a friction modifier such as graphite may also be included in base layer 10.

Outer layer sheet 12 includes fibers, filler material and a binder. The fibers may consist of cellulose fibers. The fillers consist of cylindrical, random or disc-shaped diatomaceous earth. In one preferred embodiment, the diatomaceous earth particles have a mean diameter of 30 to 80 microns. The binder can be a phenolic resin, a latex or a silane. Optionally a friction modifier such as graphite may also be included in outer layer 12. The composition of outer layer sheet 12 includes a higher ratio of filler material and a lower ratio of fibers than base layer sheet 10, such that outer layer sheet 12 is less porous and more dense than base layer sheet 10, has a higher coefficient of friction than base layer sheet 10 and a higher wear resistance than base layer sheet 10. The fibers of layers 10 and 12 have a mean diameter of 25 to 35 microns and a mean length of 1 to 2 millimeters.

In some preferred embodiments, base layer 10 includes, by percentage weight, 35 to 60% fibers, 15 to 40% filler material and 20 to 30% binder. More specifically, for higher temperature applications, base layer sheet may include, by percentage weight, 35 to 55% aramid fibers, 15 to 40% filler, which in some preferred embodiments consists only of diatomaceous earth, and 20 to 30% binder.

Outer layer sheet 12 consists of 35 to 55% diatomaceous earth, 15 to 40% cellulose fiber and 20 to 30% binder.

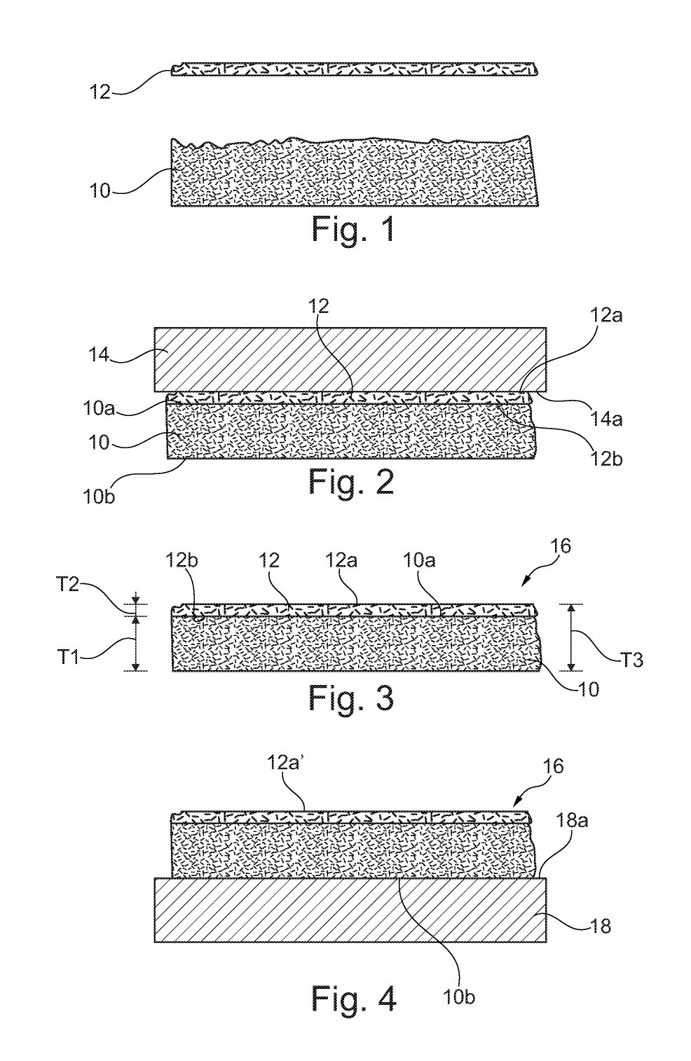

FIG. 2 shows the two separate layers 10, 12 being joined together via lamination. The lamination includes pressing outer layer 12 against base layer 10 with a heat plate 14 to cure the binder in at least one of layers 10, 12, fixing outer layer 12 and base layer 10 together. The binder is provided into the pores of a matrix formed by the fibers and the filler material of layers 10, 12. The force of pressing of heat plate 14 against an outer surface 12a of outer layer sheet 12, while a lower surface 12b of outer layer sheet 12 rests on a support surface, causes the binder to accumulate at an interface of an inner surface 12b of outer layer sheet 12 and an outer surface 10a of base layer sheet 10, while the curing of the binder by the heat of heat plate 14 creates a permanent connection between base layer sheet 10 and outer layer sheet 12. In one preferred embodiment, the heat at a surface 14a of plate 14 that contacts outer surface 12a of outer layer sheet is 375 to 425 degrees F.

Layers 10, 12 are attached to each other with adhesive or physical interactions which may include hydrogen bonding and dipole-dipole interactions. Hydrogen bonding involves intermolecular interaction between an H atom that is chemically bonded with one of F, O, N atoms and another of F, O, N atoms existing nearby. These interactions occur between mainly polar compounds. Due to the presence of hydroxyl groups (—OH) in cellulose and diatomaceous earth and amide groups (—NHC═O) in aramid fibers, hydrogen bonding occurs between separate layers of paper compounds. When layers 10, 12 are put together, they have sufficient binding strength during the production and phenolic resin can also be used to provide the main strength of the material in the end use.

FIG. 3 shows a wet friction material 16 formed by the joining of base layer sheet 10 and outer layer sheet 12 as described with respect to FIG. 2. Wet friction material 16 is formed such that outer layer sheet 12 has a thickness T1 between outer surface 12a and inner surface 12b, base layer sheet 14 has a thickness T2 between outer surface 10a and lower surface 10b, and wet friction material 16 has a total thickness T3 between outer surface 10a and lower surface 10b. In one preferred embodiment, the thickness T2 of outer layer sheet 12 is equal 10 to 30% of the total thickness T3, with thickness T1 of base layer sheet 10 thus being 70 to 90% of the total thickness T3.

FIG. 4 shows wet friction material 16 bonded to a metal part 18. More specifically, adhesive is applied to lower surface 10b of base layer sheet 10 or to a surface 18a of metal part 18 and wet friction material 16 is bonded to metal part 18 with surface 12a facing away from metal part 18.

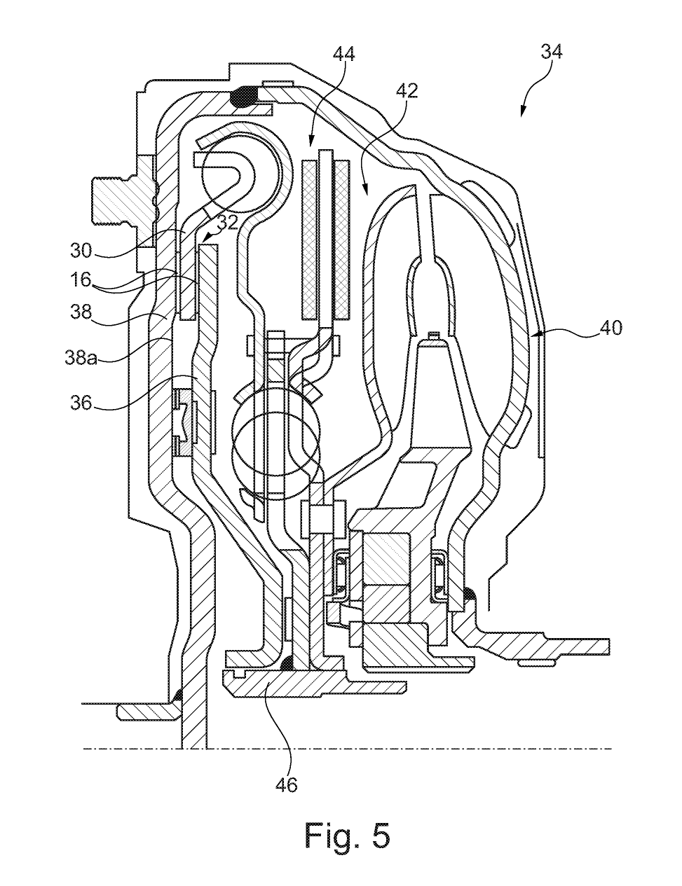

FIG. 5 shows wet friction material 16 bonded to both sides of a metal part in the form of a clutch plate 30 of lockup clutch assembly 32 of a torque converter 34. A piston 36 of lockup clutch assembly 32 forces clutch plate 30 against an inside surface 38a of a front cover 38 of torque converter 34. Piston 36 contacts the surface 12a (FIG. 3) of the rear piece of wet friction material 16 to force the surface 12a on the front piece of wet friction material 16 against inside surface 38a of front cover 38. The forcing of clutch plate 30 against front cover 38 by piston 36 locks the lockup clutch assembly 32 such that a torque path in torque converter 34 to a transmission input shaft bypasses an impeller 40 and a turbine 42 of torque converter 34, and instead flows from front cover 38 to clutch plate 30 and through a damper assembly 44 to a transmission input shaft that is connected to an output hub 46 of torque converter 34.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

10 base layer sheet
10a outer surface
10b lower surface
12 outer layer sheet
12a outer surface
12b inner surface
14 heat plate
14a plate surface
16 wet friction material
18 metal part
18a surface
30 clutch plate
32 lockup clutch assembly
34 torque converter
36 piston
38 front cover
38a inside surface
40 impeller
42 turbine
44 damper assembly
46 output hub

What is claimed is:

1. A method of making a wet friction material comprising:
obtaining a base layer sheet;
obtaining an outer layer sheet; and
laminating the outer layer sheet and the base layer sheet together to form the wet friction material, the base layer sheet including a proportion of first fiber material and a proportion of first filler material, the outer layer sheet including a proportion of second fiber material and a proportion of second filler material, the proportion of second fiber material being less than the proportion of first fiber material, the proportion of second filler material being greater than the proportion of first filler material.

2. The method as recited in claim 1 wherein the base layer sheet has a first thickness and the outer layer sheet has a second thickness, the wet friction material having a total thickness equaling the first thickness plus the second thickness, the second thickness being 10% to 30% of the total thickness.

3. The method as recited in claim 1 wherein the second filler material consists of diatomaceous earth.

4. The method as recited in claim 3 wherein the diatomaceous earth forms 35 to 55% by percentage weight of the outer layer sheet.

5. The method as recited in claim 1 wherein the second fiber material consists of cellulose fibers.

6. The method as recited in claim 1 wherein the first filler material is formed by one or more fillers from a group consisting of diatomaceous earth and/or clay.

7. The method as recited in claim 1 wherein the first filler material consists of diatomaceous earth.

8. The method as recited in claim 1 wherein the first fiber material consists of aramid fibers and cellulose fibers.

9. The method as recited in claim 1 wherein the first fiber material consists of aramid fibers.

10. The method as recited in claim 1 wherein the first fiber proportion is 35 to 60% by percentage weight of the base layer sheet.

11. The method as recited in claim 1 wherein at least one of the base layer and the outer layer includes a binder and the laminating of the outer layer on the base layer applying heat and pressure to the outer layer to fix the outer layer and the base layer together via the binder.

12. A method of making a part of a friction clutch comprising:
making the wet friction material with the method as recited in claim 1; and
fixing the wet friction material to a metal part.

13. A wet friction material comprising:
a base layer sheet; and
an outer layer sheet laminated onto the base layer sheet, the base layer sheet including a proportion of first fiber material and a proportion of first filler material, the outer layer sheet including a proportion of second fiber material and a proportion of second filler material, the proportion of second fiber material being less than the proportion of first fiber material, the proportion of second filler material being greater than the proportion of first filler material.

14. The wet friction material as recited in claim 13 wherein the base layer sheet has a first thickness and the outer layer sheet has a second thickness, the wet friction material having a total thickness equaling the first thickness plus the second thickness, the second thickness being 10% to 30% of the total thickness.

15. The wet friction material as recited in claim 13 wherein the second filler material consists of diatomaceous earth.

16. The wet friction material as recited in claim 15 wherein the diatomaceous earth forms 35 to 55% by percentage weight of the outer layer sheet.

17. The wet friction material as recited in claim 13 wherein the second fiber material consists of cellulose fibers.

18. The wet friction material as recited in claim 13 wherein the first filler material consists of diatomaceous earth.

19. The wet friction material as recited in claim 13 wherein the first fiber material consists of aramid fibers or aramid fibers and cellulose fibers.

20. The wet friction material as recited in claim 13 wherein the first fiber proportion is 35 to 60% by percentage weight of the base layer sheet.
